(19) United States
(12) Patent Application Publication
(10) Pub. No.: US 2013/0024802 A1
(43) Pub. Date: Jan. 24, 2013

(54) PRESETTING INPUT MODE FOR INPUT BOX

(71) Applicant: Jun Zeng, Shanghai (CN)

(72) Inventor: Jun Zeng, Shanghai (CN)

(73) Assignee: INTERNATIONAL BUSINESS MACHINES CORPORATION, Armonk, NY (US)

(21) Appl. No.: 13/546,720

(22) Filed: Jul. 11, 2012

(30) Foreign Application Priority Data
Jul. 21, 2011 (CN) 201110212539.X

(51) Int. Cl. G06F 3/048

(52) U.S. Cl. 715/780

(57) ABSTRACT

The present invention discloses a method and system for presetting an input mode for an input box, wherein the method comprises: in response to an input box being to receive an input, making a query for an input mode corresponding to the input box recorded in an input method; and presetting the input mode found through the query as the input mode for the input box. With the disclosed method and system, when a user needs to input information in an input box in accessing an application or the internet, the input method can automatically preset a desired input mode for the input box according to the use history of the input box, thus improving the user's experience.

### TECHNICAL FIELD

The present invention generally relates to input method applications, and more specifically, to a method and system for presetting an input mode for an input box.

### BACKGROUND ART

Nowadays there have been more and more electronic devices, such as computers, mobile phones, PDAs, and the like. These electronic devices often need to interact with users, wherein the users input interaction information like user name, password, verification code, etc. Viewed widely, this kind of interaction information is generally input via application input boxes. When making a specific input, the user may use a suitable input method to input the information required by the input box. Moreover, when accessing a network, the user often needs to interact with the webpages of the service provider. For example, the user need to fill out registration information when registering, fill out the user name and password when accessing, and use Chinese or English input when writing comments, etc.

An input method is also a kind of application. Upon completion of installation of an operating system and suitable input methods, these input methods can be used to input information required by the user input box. There are many input methods. For computers, due to the rich keyboard information, their input methods are normally different from the input methods of those electronic devices having a simple keyboard like mobile phones. The commonly used input methods in computers include: Google input method, Microsoft intelligent ABC input method, Baidu input method, ect. The commonly used input methods in mobile phones include: Motorola input method, Sogou mobile phone input method, Google mobile phone input method, etc. Each specific input method includes multiple modes. In computers which have large keyboards including rich information, the capital and lowercase letters can be switched by the Shift key and separate keys are provided for digits, therefore, the modes are few and mainly include Chinese and English modes. For mobile phones and other small digital intelligent devices which have small keyboards, there are many input modes including Chinese mode, English capital letter mode, English lowercase letter mode, digit mode, symbol mode, and the like. Mode switching is often needed when the user is making an input.

### SUMMARY OF INVENTION

In input boxes for applications and webpages, many input boxes have specific requirements for input. For example, some input boxes require inputting Chinese only, such as user name in real name system, and some input boxes require inputting digits only, such as filling out birthday information, and the like. Generally speaking, a current input box, if having such requirements, will indicate beside the input box that the input box only accepts Chinese, English or digit input, and then the user adjusts the input mode according to that indication to thereby switch to the desired input mode for making an input. Mode switching will consume the user's input time, especially, when the user is unfamiliar with the input mode switching and needs to input information in the input box in accessing applications or webpages on intelligent devices like mobile phones, frequent input mode switching will significantly reduce the user's experience.

Therefore, there exists a need for a method and system for automatically presetting an input mode for an input box according to a user's use history of the input box, so that when the user needs to input information in the input box in accessing an application or the internet, the input method can automatically preset a desired input mode for the input box according to a record of the use history of the input box and thus improve the user's experience.

According to one aspect of the present invention, there is provided a method for presetting an input mode for an input box, comprising: in response to an input box being to receive an input, making a query for an input mode corresponding to the input box recorded in an input method; and presetting the input mode found through the query as the input mode for the input box.

According to another aspect of the present invention, there is provided a system for presetting an input mode for an input box, comprising: a query module configured to make a query for an input mode corresponding to the input box recorded in an input method; and a presetting module configured to preset the input mode found through the query as the input mode for the input box.

### BRIEF DESCRIPTION OF THE DRAWINGS

With a more detailed description of the illustrative embodiments of the present invention in the drawings, the above and further objects, features and advantages will become more apparent, wherein the same reference numbers indicate the same elements in the illustrative embodiments of the present invention.

FIG. 1 shows a block diagram of an exemplary computing system 100 for implementing the embodiments of the present invention.

FIG. 2 shows input modes commonly used in mobile phones.

FIG. 3 shows a flowchart of a method for presetting an input mode for an input box according to a preferred embodiment of the present invention.

FIG. 4 shows another embodiment for step 301.

FIG. 5 shows an example of application input box objects contained in an object library.

FIG. 6 shows an example of webpage input box objects contained in an object library.

FIGS. 7A, 7B and 7C show three more simple expressions used by an input history library.

FIG. 8 shows a structural block diagram of a system for presetting an input mode for an input box.

### BEST MODES FOR CARRYING OUT THE INVENTION

The preferred embodiments of the present invention will be explained in more detail with reference to the accompanying drawings. However, the present invention may be implemented in various forms but should not be construed as being limited by the embodiments set forth herein. Rather, these embodiments are provided to facilitate a more thorough and complete understanding of the present invention and to fully convey the scope of the present invention to those skilled in the art.

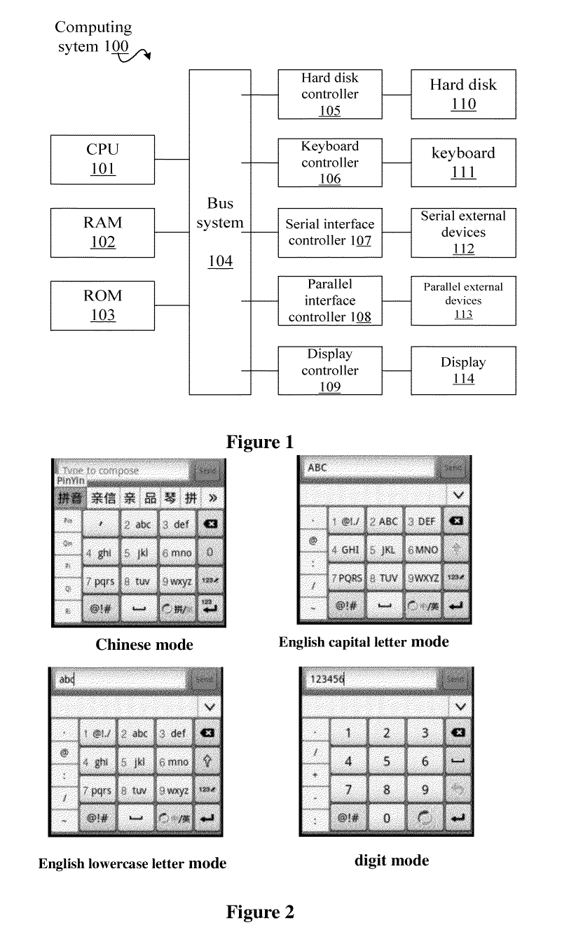

FIG. 1 shows a block diagram of an exemplary computing system 100 suitable for implementing the embodiments of the present invention. As shown, the computing system 100 may include: CPU (central processing unit) 101, RAM (random access memory) 102, ROM (read only memory) 103, system bus 104, hard disk controller 105, keyboard controller 106, serial interface controller 107, parallel interface controller 108, display controller 109, hard disk 110, keyboard 111, serial external device 112, parallel external device 113 and display 114. Among these devices, CPU 101, RAM 102, ROM 103, hard disk controller 105, keyboard controller 106, serial interface controller 107, parallel interface controller 108 and display controller 109 are coupled to system bus 104. Hard disk 110 is coupled to hard disk controller 105, keyboard 111 is coupled to keyboard controller 106, serial external device 112 is coupled to serial interface controller 107, parallel external device 113 is coupled to parallel interface controller 108, and display 114 is coupled to display controller 109. It should be appreciated that, the structural block diagram of FIG. 1 is only for illustration purposes but not for limiting the scope of the present invention. In some cases, some devices may be added or omitted depending on the specific situations.

FIG. 2 shows input modes commonly used in mobile phones, including Chinese mode, English capital letter mode, English lowercase letter mode, digit mode, symbol mode, etc.

Currently, regarding the input for application input box or input for webpage input box, if a user is required to input in a certain mode, e.g., Chinese input, English input or digit input, it is normally indicated beside the input box that the input box only accepts Chinese input, English input or digit input. During the specific programming by a programmer, if it is required to directly preset the input mode for the input box without a need for the user to select an input mode next time, those skilled in the art will typically record in the application the input mode used by the user for that input box, and when the input box requests an input, the corresponding mode of the input method is activated. During programming, this implementation results in a complex program for each input box, since it cannot be predicted which input method is to be used by the user. Moreover, since applications or accessed webpages often have many input boxes and each input box needs similar programming, the workload is heavy and trivial, and many programs will be involved in case of failure of one module.

The present invention has proposed a method and system for presetting an input mode for an input box, which records in an input method the input mode previously used by the user for that input box. Thus, the input modes for all the input boxes can be maintained by only maintaining one application of input method, the programming and maintenance for the automatic presetting of the input mode for the input box are made easy and excellent user experience can be achieved at minimum costs.

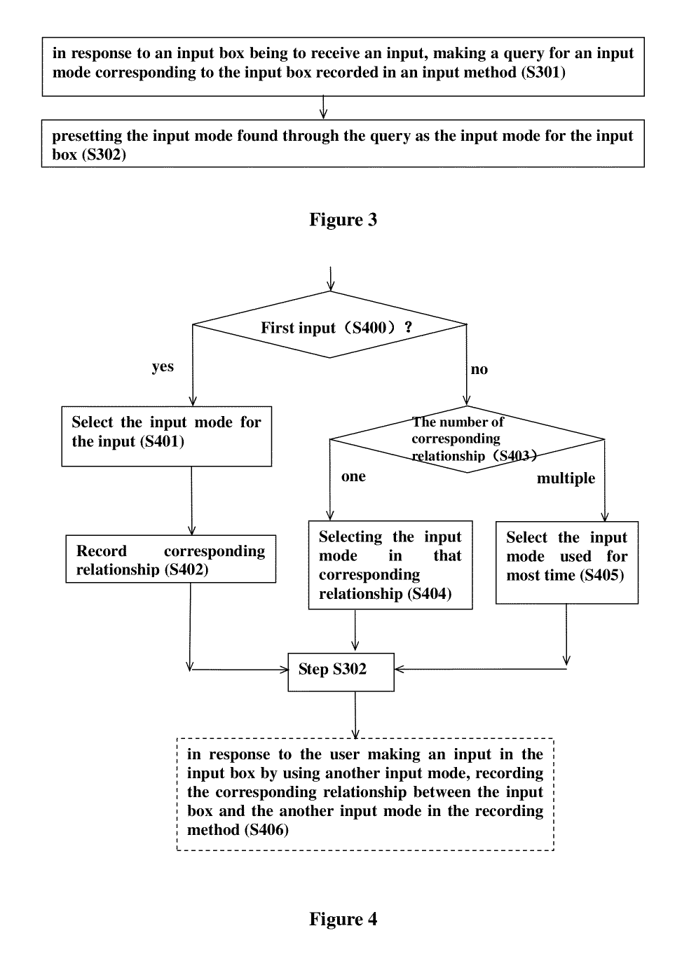

FIG. 3 shows a flowchart of a method for presetting an input mode for an input box according to a preferred embodiment of the present invention. According to FIG. 3, the method includes: at step S301, in response to an input box being to receive an input, making a query for an input mode corresponding to the input box recorded in an input method; and at step S302, presetting the input mode found through the query as the input mode for the input box. As such, the user can make an input at the input box by using the input mode for the input box. The presetting here means that when the user makes a marker denoting input (e.g., a mouse or a cursor) stay at the input box, the input method automatically set its input mode as the input mode for the input box, to facilitate the user to use the input box.

The input box here may be an input box for application, and may be an input box in webpage. In either case, the input mode corresponding to the input box is obtained from corresponding relationship between the input box and the input mode used by a user for the input box recorded in the input method. With respect to an input box for application, in one embodiment of step S301, the corresponding relationship between the input box and the input mode used by a user for the input box recorded in the input method can be obtained by, in installation of application, the installation program finding the input method installed in the operating system and then recording the corresponding relationship between each input box and the input mode used by a user for that input box. Correspondingly, in accessing a webpage, an applet may be automatically downloaded from the webpage at the user's first access. The applet is used to find the input method installed in the operating system, and then the corresponding relationship between each input box and the input mode used by a user for the input box is recorded in the input method. This implementation needs support of application programming, that is, the programmer needs additional development work in application development, and the implementation also needs support of input method. Communication between the application and the input method is required to solve the technical problem and to achieve the above desired effects. However, since these two applications belong to different manufacturers and their own interfaces need to be published, it is inconvenient to implement the solution.

FIG. 4 shows another embodiment for step 301, wherein the user's single input may be used to record the corresponding relationship between each input box and the input mode used by a user for the input box. In FIG. 4, step S301 is replaced with steps S400-S404. At step S400, it is determined whether the input is a first input for the input box; if yes, the input method has not recorded corresponding relationship between each input box and the input mode used by a user for the input box, and therefore, the user must switch the input modes by himself/herself, that is, at step S401, in response to the input being the first input for the input box, selecting the input mode used by the user for the input box as the input mode corresponding to the input box; and then at step S402, recording the corresponding relationship between the input box and the input mode used by the user for the input box in the input method. As such, the corresponding relationship between the input box and the input mode used by the user for the input box may not be updated later and the input mode selected by the user can continue to be used. Moreover, the order between step S401 and step S402 may be changed without affecting the performance of the solution. In another embodiment, at step S403, in response to the input not being the first input for the input box, it is determined whether a plurality of corresponding relationship between the input box and the input mode used by the user for the input box are recorded in the input method. This is a preferred step, the determination may be omitted and at step S404, in response to the input not being the first input for the input box and one corresponding relationship between the input box and the input mode used by the user for the input box being recorded in the input method, selecting the input mode in that corresponding relationship as the input mode corresponding to the input box, then the process returns to step S302. The determination step S403 is provided for a plurality of subsequent corresponding relationship.

FIG. 4 shows another embodiment for step 301, wherein the user's a plurality of inputs may be used to record a plurality of corresponding relationship between each input box and the input mode used by a user for the input box. In FIG. 4, step S301 is replaced with steps S400-S403 and steps S405-S406. Steps S400-S403 are the same as the those mentioned above, and the description thereof is omitted. At step S405, in response to the input not being the first input for the input box and a plurality of corresponding relationship between the input box and the input mode used by the user for the input box being recorded in the input method, the input mode used for most times is selected as the input mode corresponding to the input box. In an alternative at step S405, in response to the input not being the first input for the input box and a plurality of corresponding relationship between the input box and the input mode used by the user for the input box being recorded in the input method, the input mode used most recently is selected as the input mode corresponding to the input box. Then return to step S302 for mode presetting. After mode presetting, for recording a plurality of corresponding relationship between the input box and the input mode used by the user for the input box, at step S406, in response to the user making an input in the input box by using another input mode, recording the corresponding relationship between the input box and the another input mode in the recording method. At this time, the user may directly use the preset input mode, and may also switch the input mode again by keyboard operation, here the user may record the last used mode for subsequent selection.

The corresponding relationship between the input box and the input mode used by the user for the input box is expressed in the form of a pair of unique key for input box and input mode.

For application input boxes, each input box has its own attributes and attribute values, such as class, name, type, text, id, and the like, and one or more attributes can compose a unique key. In order to differentiate input boxes on different windows, it must be recorded on which window an input box is located. If there are multiple levels of parental windows, a record should be made until the window at the top level. Similar to the input box, a window also has attributes and attribute values, such as class, title, name, id, etc. of a window control. From the attributes and attribute values of the top level window with a highest priority, to the attributes and attribute values of the input box, such an attribute set composes a unique key for object. That is to say, the unique key for the application input box includes the attributes and attribute values of each level of parental window of the input box and the attributes and attribute values of the input box.

For a webpage input box, the webpage on which it is located is determined by recording URL of the webpage and the attributes and corresponding attribute values, such as name, type, id and tag of the input box are recorded. By means of corresponding attributes, it can be determined the input box is which input box on which webpage. That is to say, the unique key for the webpage input box includes the location of the webpage and the attributes and attribute values of the input box.

In one embodiment, an object library may be added into the input method. As long as the input box has also been input, the object library will have a corresponding record. The unique key for the input box and the ID of input box object can be correlated and mapped in the object library. FIG. 5 shows an example of application input box objects contained in an object library, wherein the object library includes two objects, input box object 1 and input box object 2. Input box object 1 includes an input box entitled “user name input” which is located under “login window”, and the unique key for the input box includes the window attributes and attribute values of the “login window” and the attributes and attribute values of the input box of “user name input”. Likewise, input box object 2 includes an input box entitled “number of goods”, which is located under “shopping window”, and the unique key for the input box includes the window attributes and attribute values of the “login window” and the attributes and attribute values of the input box of “number of goods”.

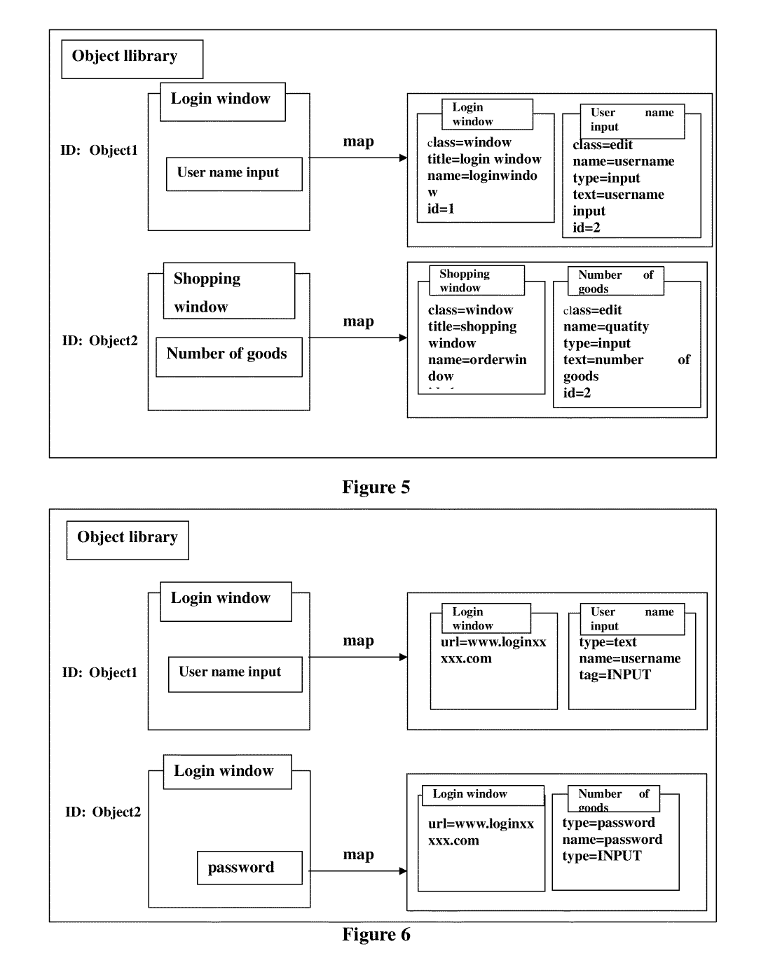

For webpage input boxes, objects can be established in an object library of the input method. That is to say, the unique key for the input box includes the location of the webpage and the attributes and the attribute values of the input box. Likewise, FIG. 6 shows an example of webpage input box objects contained in an object library, which includes two webpage input box objects, input box object 1 and input box object 2. Input box object 1 is an input box entitled “user name input” which is located at the webpage of “login window”, and the unique key for the input box includes the attributes and attribute values of the webpage of “login window” and attributes and the attribute values of the input box itself. Likewise, input box object 2 is an input box entitled “password” which is located at the webpage of “login window”, and the unique key for the input box includes the attributes and attribute values of the webpage of “login window” and attributes and the attribute values of the input box of itself.

Moreover, in the input method, the object library recording the unique key for input boxes may have many implementations, such as XML, database, text document and the like. The following is an example of a text document.

The unique key for the application input box is:

Object1=class:window, title=login window, name=loginwindow, id=1; class=edit, name=username, type=input, text=username input, id=2

The unique key of the webpage input box is:

Object1=url: www.loginxxxxx.com, type=password, name=password, type=INPUT.

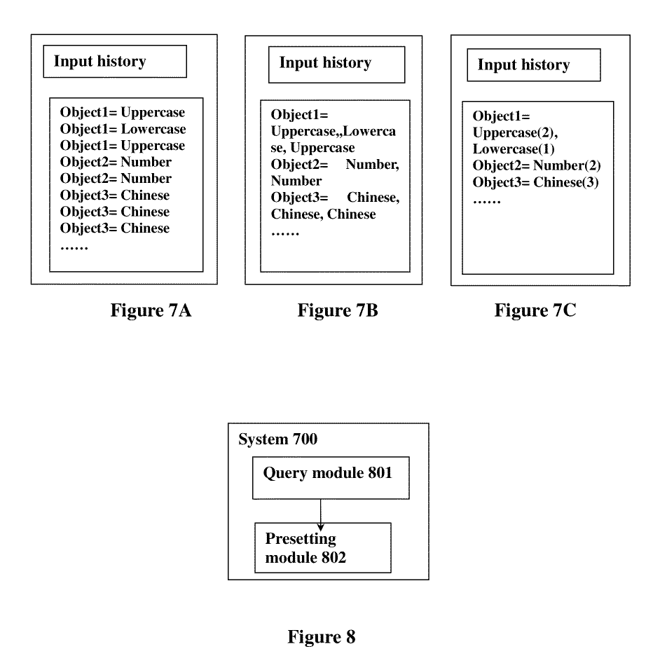

The object library may also include therein corresponding relationship between the input box object and the input mode used by a user for the input box. All the corresponding relationship may be recorded in one table of the object library. Alternatively, the latest corresponding relationship may be put in one table and the historical data may be put in another table. The historical data may even be put in a further history library. As shown in FIGS. 7A, 7B and 7C, in FIG. 7A, the input mode of each time is recorded respectively; in FIG. 7B, for an object, only one input mode use record is maintained, but all the uses are saved by means of delimiters; in FIG. 7C, for an object, only one input mode use record is maintained, and the number of times of the input mode uses is recorded.

In one embodiment, the determination as to whether the input is a first input for the input box is made on basis of the corresponding relationship in the object library in the input method. When the input box obtains a focus (for example, the user makes the mouse stay at that point or move the cursor to the point by keyboard), that is to say, the input box is to receive an input, a snooper in the input method finds this action, and obtains the attributes and attribute values of the input box. Next, a search is made in the unique key records of object library of the input method. If no unique key record is found, it indicates the first input, and if a unique key record can be found, it indicates that the input is not the first input.

If the input is the first input, according to the input mode used by the user this time, the unique key of the input box is recorded according to the method steps described above, and a corresponding relationship record is generated in the object library and use history. Statistic results may be generated based on a plurality of corresponding relationship, to perform the selection of input modes for the input box.

As such, a suitable input mode may be easily selected for an application input box or webpage input box by using the input of the user and the input history. It is easy to implement and improves the user's experience.

Of course, the above object library is only a specific implementation, those skilled in the art can appreciate that the present invention can be implemented in various equivalent forms such as file systems, tables, etc. These equivalent implementations are all within the protection scope of the present invention.

Under the same inventive concept, the present invention also discloses a system for presetting an input mode for an input box. FIG. 8 shows the structure of a system 800. According to FIG. 8, the system 800 comprises: a query module 801, configured to make a query for an input mode corresponding to the input box recorded in an input method; and a presetting module 802, configured to preset the input mode found through the query as the input mode for the input box. As such, the user can make an input at the input box in the input mode corresponding to the input box. The input mode corresponding to the input box found through the query by the query module is obtained from corresponding relationship between the input box and the input mode used by a user for the input box recorded in the input method.

In one embodiment, the query module 801 includes (not shown in FIG. 8): a determining module configured to determine whether the input is the first input for the input box; a first-processing module configured to, in response to the input being the first input for the input box, select the input mode used by the user for the input box as the input mode corresponding to the input box and record the corresponding relationship between the input box and the input mode used by the user for the input box in the input method. In another embodiment, the query module further comprises: a non-first-processing module configured to, in response to the input not being the first input for the input box and one corresponding relationship between the input box and the input mode used by the user for the input box being recorded in the input method, select the input mode in that corresponding relationship as the input mode corresponding to the input box.

In another embodiment, the query module 801 includes (not shown in FIG. 8): a non-first-processing module configured to, in response to the input not being the first input for the input box and a plurality of corresponding relationship between the input box and the input mode used by the user for the input box being recorded in the input method, select the input mode used for most times as the input mode corresponding to the input box.

In another embodiment, the query module 801 includes (not shown in FIG. 8): a non-first-processing module configured to, in response to the input not being the first input for the input box and a plurality of corresponding relationship between the input box and the input mode used by the user for the input box being recorded in the input method, select the input mode used most recently as the input mode corresponding to the input box.

In a further embodiment, the non-first-processing module is further configured to, in response to the user making an input in the input box by using another input mode, record the corresponding relationship between the input box and the another input mode in the recording method.

In the system, the corresponding relationship between the input box and the input mode used by the user for the input box is expressed in the form of a pair of unique key for input box and input mode. If the input box is an application input box, the unique key for the input box includes attributes and attribute values of each level of parental window of the input box and attributes and attribute values of the input box. If the input box is a webpage input box, the unique key for the input box includes a location of the webpage and the attributes and attribute values of the input box. In addition, the determination by the determining module as to whether the input is the first input for the input box is made on basis of the record in the object library established in the input method.

The present invention may be implemented in the form of hardware embodiment, software embodiment, and both hardware and software embodiment. In a preferred embodiment, the present invention is implemented as software, including but not limited to firmware, resident software and microcode, and the like.

Moreover, the present invention may adopt the form of computer program product accessible from computer usable or computer readable media, these media provide program code for use by or in conjunction with computer or any instruction executing system. For purpose of illustration, computer usable or computer readable mechanism may be any tangible means, which may include, store, communicate, propagate or transport programs for use by or in conjunction with instruction executing system, apparatus or device.

The media may be electrical, magnetic, optical, electromagnetic, infrared or semiconductor system (or apparatus or device) or propagation media. Examples of computer readable media include semiconductor or solid memory, magnetic tape, removable computer magnetic disk, random access memory (RAM), read only memory (ROM), hard disk and optical disk. Current examples of optical disk include compact disk-read only memory (CD-ROM), compressible disk-read/write (CD-R/W) and DVD.

Data processing system suitable for storing and/or executing program code will include at least one processor, which is directly or indirectly coupled to memory elements. Memory elements may include local memory and mass storage used during actual execution of the program code, and cache memory which provide temporal storage of at least part of the program code to reduce the number of times for retrieving codes from mass storage during execution.

Input/output or I/O devices (including but not limited to keyboard, display and pointing device, and the like) may be coupled to the system directly or via intervening I/O controller.

Network adapters may also be coupled to the system, so that the data processing system can be coupled to other processing system or remote printer or storage devices via private or public network. Modem, cable modem and ethernet card are only a few examples of currently available network adapters.

From the above description it can be understood that, without departing from the true spirit of the present invention, modification and changes can be made to the embodiments of the present invention. The description is only illustrative but shall not be regarded as limiting. The scope of the present invention is only defined by the appending claims.

1. A method for presetting an input mode for an input box, comprising:
in response to an input box being to receive an input, making a query for an input mode corresponding to the input box recorded in an input method; and
presetting the input mode found through the query as the input mode for the input box.

2. The method according to claim 1, wherein the input mode corresponding to the input box is obtained from the corresponding relationship between the input box and the input mode used by a user for the input box recorded in the input method.

3. The method according to claim 2, wherein the step of making a query for the input mode corresponding to the input box recorded in the input method comprises:
determining whether the input is a first input for the input box;
in response to the input being the first input for the input box, selecting the input mode used by the user for the input box as the input mode corresponding to the input box;
recording the corresponding relationship between the input box and the input mode used by the user for the input box in the input method.

4. The method according to claim 3, wherein the step of making a query for the input mode corresponding to the input box recorded in the input method further comprises:
in response to the input not being the first input for the input box and one corresponding relationship between the input box and the input mode used by the user for the input box being recorded in the input method, selecting the input mode in that corresponding relationship as the input mode corresponding to the input box.

5. The method according to claim 3, wherein the step of making a query for the input mode corresponding to the input box recorded in the input method further comprises:
in response to the input not being the first input for the input box and a plurality of corresponding relationship between the input box and the input mode used by the user for the input box being recorded in the input method, selecting the input mode used for most times as the input mode corresponding to the input box.

6. The method according to claim 3, wherein the step of making a query for the input mode corresponding to the input box recorded in the input method further comprises:
in response to the input not being the first input for the input box and a plurality of corresponding relationship between the input box and the input mode used by the user for the input box being recorded in the input method, selecting the input mode used most recently as the input mode corresponding to the input box.

7. The method according to claim 5, wherein the step of making a query for the input mode corresponding to the input box recorded in the input method further comprises:
in response to the user making an input in the input box by using another input mode, recording the corresponding relationship between the input box and said another input mode in the recording method.

8. The method according to claim 2, wherein the corresponding relationship between the input box and the input mode used by the user for the input box is expressed in the form of a pair of unique key for input box and input mode.

9. The method according to claim 8, wherein the input box is an application input box, and the unique key for input box includes attributes and attribute values of each level of parental window of the input box and attributes and attribute values of the input box.

10. The method according to claim 8, wherein the input box is a webpage input box, and the unique key for input box includes a location of the webpage and attributes and attribute values of the input box.

11. A system for presetting an input mode for an input box, comprising:
a query module configured to make a query for an input mode corresponding to the input box recorded in an input method; and
a presetting module configured to preset the input mode found through the query as the input mode for the input box.

12. The system according to claim 11, wherein the input mode corresponding to the input box found through the query by the query module is obtained from corresponding relationship between the input box and the input mode used by a user for the input box recorded in the input method.

13. The system according to claim 12, wherein the query module comprises:
a determining module configured to determine whether the input is a first input for the input box;
a first-processing module configured to, in response to the input being the first input for the input box, select the input mode used by the user for the input box as the input mode corresponding to the input box, and record the corresponding relationship between the input box and the input mode used by the user for the input box in the input method.

14. The system according to claim 13, wherein the query module further comprises:
a non-first-processing module configured to, in response to the input not being the first input for the input box and one corresponding relationship between the input box and the input mode used by the user for the input box being recorded in the input method, select the input mode in that corresponding relationship as the input mode corresponding to the input box.

15. The system according to claim 13, wherein the non-first-processing module is further configured to, in response to the input not being the first input for the input box and a plurality of corresponding relationship between the input box and the input mode used by the user for the input box being recorded in the input method, select the input mode used for most times as the input mode corresponding to the input box.

16. The system according to claim 13, wherein the non-first-processing module is further configured to, in response to the input not being the first input for the input box and a plurality of corresponding relationship between the input box and the input mode used by the user for the input box being recorded in the input method, select the input mode used most recently as the input mode corresponding to the input box.

17. The system according to claim 15, wherein the non-first-processing module is further configured to, in response to the user making an input in the input box by using another input mode, record the corresponding relationship between the input box and said another input mode in the recording method.

18. The system according to claim 12, wherein the corresponding relationship between the input box and the input mode used by the user for the input box is expressed in the form of a pair of unique key for input box and input mode.

19. The system according to claim 18, wherein the input box is an application input box, and the unique key for input box includes attributes and attribute values of each level of parental window of the input box and attributes and attribute values of the input box.

20. The system according to claim 18, wherein the input box is a webpage input box, and the unique key for input box includes a location of the webpage and attributes and attribute values of the input box.
